(19) United States
(12) Patent Application Publication
(10) Pub. No.: US 2025/0276752 A1
(43) Pub. Date: Sep. 4, 2025

(54) Clamping Device for Fastening a Component to a Bicycle Handlebar

(71) Applicant: Robert Bosch GmbH, Stuttgart (DE)

(72) Inventors: Joao Pedro Ribeiro Pedrosa Pinto, Stuttgart (DE); Omkar Ravindra Patil, Pune (IN); Raul Montanez Gimenez, Stuttgart (DE); Rui Fernandes, Reutlingen (DE)

(21) Appl. No.: 19/062,978

(22) Filed: Feb. 25, 2025

(30) Foreign Application Priority Data
Mar. 1, 2024 (DE) 10 2024 201 907.0

(51) Int. Cl. B62J 7/06; B62J 7/08

(52) U.S. Cl. CPC B62J 7/06; B62J 7/08

(57) ABSTRACT

A clamping device for fastening a component to a bicycle handlebar includes (i) an open, annular base body bent around a central axis having a first circumferential end and a second circumferential end, and (ii) a locking area configured to form a detachable snap connection with the component. The base body is configured to enclose the bicycle handlebar. A joining gap is formed between the first circumferential end and the second circumferential end. The locking area is arranged at the first circumferential end. The first circumferential end and the second circumferential end are configured to be connected by a fastening element along a fastening axis in order to fix the clamping device to the bicycle handlebar. The locking area is configured to fix the component by way of the fastening element.

This application claims priority under 35 U.S.C. § 119 to application no. DE 10 2024 201 907.0, filed on Mar. 1, 2024 in Germany, the disclosure of which is incorporated herein by reference in its entirety.

### Background

The present disclosure relates to a clamping device for fastening a component to a bicycle handlebar, a clamping assembly and a method for fastening a component to a bicycle handlebar.

Clamping devices for fastening components to a bicycle handlebar are known in the prior art in various embodiments. In order to fasten a component to a bicycle handlebar with the aid of a clamping device according to the prior art, a complex assembly process is usually necessary. This may comprise a variety of assembly steps. Often, an extensive alignment of the components with respect to one another is also necessary.

It would be desirable to have a clamping device for fastening components to a bicycle handlebar, which allows for intuitive and fast assembly of components on a bicycle handlebar while being simple and inexpensive to manufacture.

### SUMMARY

The clamping device according to the disclosure for fastening a component to a bicycle handlebar with the features set forth below has the advantage that the component can be easily aligned and fastened in a locking area of the clamping device, wherein the clamping device and the component can then be fixed to the bicycle handlebar with a fastening element. According to the present disclosure, this is achieved by the clamping device comprising an open, annular base body bent about a central axis with a first circumferential end and a second circumferential end, which is configured to enclose the bicycle handlebar. A joining gap is configured between the first circumferential end and the second circumferential end. Furthermore, the clamping device comprises a locking area, which is arranged at the first circumferential end and is configured to form a detachable connection with the component. The detachable connection is in particular a detachable snap connection. The first circumferential end and the second circumferential end are configured to be connected by at least one fastening element, preferably precisely one screw, along a fastening axis in order to fix the clamping device to the bicycle handlebar. Furthermore, the locking area is configured to fix the component by way of the at least one fastening element in addition to the detachable connection. The fastening axis is preferably arranged perpendicular to the central axis. The component can thus be temporarily aligned and fastened to the clamping device with the aid of the snap connection. The clamping device and the component can then be quickly and easily fastened to the bicycle handlebar permanently with the fastening element. In particular, the clamping connection according to the disclosure enables the one-handed fixation of the component to the bicycle handlebar.

Preferred refinements of the disclosure are set forth below.

Preferably, the locking area has an undercut and a protrusion, which are configured to form the detachable snap connection with the component. The undercut and the protrusion are preferably configured in such a way that, in combination, they restrict all degrees of freedom of the component to the clamping device in order to form a positive-locking connection with the component. The protrusion is preferably resilient and forms a snap element to allow for ease of joining and detaching the snap connection. The combination of undercut and protrusion allows for a snap connection, which can be easily integrated into the clamping device and which can be used to easily fasten components to the clamping device.

Further preferably, the protrusion from the base body is arranged radially outside the fastening axis at the first circumferential end and the undercut is arranged between the central axis of the base body and the fastening axis. This allows for easy fastening and subsequent fixation of the component to the clamping device.

The first circumferential end and the second circumferential end preferably have through-holes to receive the screw. Through-holes may be manufactured inexpensively. The screw preferably engages in a thread, which is attached to the component in order to fasten the component and the clamping device to the bicycle handlebar. The through-hole in the first circumferential end is preferably of greater diameter than the through-hole in the second circumferential end.

According to a further preferred embodiment of the disclosure, the first circumferential end and/or the second circumferential end have a spacer, which is arranged radially outside the fastening axis from the base body and protrudes into the joining gap. Thus, the spacer first closes the contact between the first circumferential end and the second circumferential end, wherein the joining gap with a defined distance is still present between the first circumferential end and the second circumferential end. The joining gap may be reduced during the fastening operation with the aid of the screw, thereby ensuring reliable application of a clamping force.

The clamping device preferably comprises a guide bar, which is arranged adjacent the undercut and forms a lateral stop in the direction along the central axis. The clamping device can thus enable the simple attachment and simultaneous alignment of the component.

Further preferably, the clamping device is one-piece. Thus, the clamping device can be manufactured inexpensively in one step. Furthermore, the one-piece clamping device allows for reliable use of the clamping device.

Further, the disclosure describes a clamping assembly comprising a fastening element, a component, and a clamping device previously described. The clamping device is configured to fix the component to a bicycle handlebar by way of the fastening element. The fastening element is preferably precisely one screw. This enables a simple and reliable fastening of the component with the aid of the clamping device to the bicycle handlebar.

Further preferably, the clamping assembly is configured to fix the component below the bicycle handlebar. Thus, the center of gravity of the clamping assembly is positioned below the bicycle handlebar, allowing a stable position to fix the clamping assembly.

Furthermore, the disclosure comprises a method for fastening a component to a bicycle handlebar. In one step, a clamping device previously described is attached to a bicycle handlebar. In a further step, the component is fastened to the clamping device. In a final step, the clamping device is fixed to a bicycle handlebar and the component is fixed to the clamping device with a fastening element. The fastening element is in particular precisely one screw. Thus, the method allows a simple and reliable fastening of the component to the bicycle handlebar. The component may be fastened to the clamping device before or after the clamping device is attached to the bicycle handlebar.

### BRIEF DESCRIPTION OF THE DRAWINGS

A preferred exemplary embodiment of the disclosure is explained in detail below with reference to the accompanying drawings. The drawing shows:

FIG. 1 a schematic perspective view of a clamping device according to a first preferred exemplary embodiment of the disclosure,

FIG. 2 a detailed view of the first circumferential end of the clamping device according to the first preferred exemplary embodiment of the disclosure,

FIG. 3 a sectional view of the clamping device according to the first exemplary embodiment and a bicycle handlebar before the clamping device is attached to the bicycle handlebar,

FIG. 4 a sectional view of the bicycle handlebar and the clamping device according to the first exemplary embodiment after the clamping device has been attached to the bicycle handlebar,

FIG. 5 a sectional view of a clamping assembly according to the first preferred

exemplary embodiment of the disclosure from the clamping device and a component fixed to the bicycle handlebar with the aid of a screw,

FIG. 6 a detailed view of the clamping assembly according to the first preferred exemplary embodiment of the disclosure in the area of the joining gap, and

FIG. 7 a flow diagram of a method for fastening the component to the bicycle handlebar according to the first exemplary embodiment of the disclosure.

### DETAILED DESCRIPTION

Preferably, all identical components, elements, and/or units are provided with the same reference symbols in all figures.

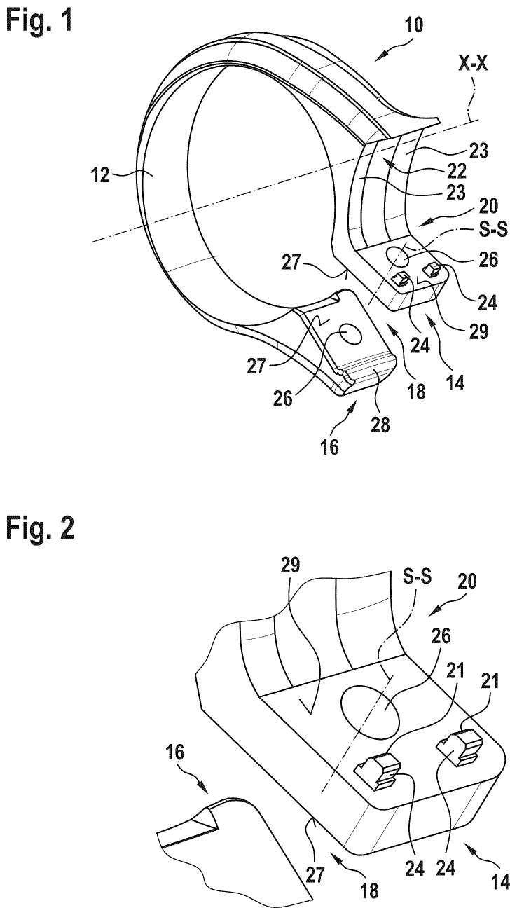

Referring to FIGS. 1 to 7, a clamping device 10, a clamping assembly 100, and a method for fastening a component 40 to a bicycle handlebar 50 according to a first exemplary embodiment will be described in detail below.

FIG. 1 shows a perspective view of the clamping device 10. The clamping device 10 comprises an open annular base body 12 bent about a central axis X-X. The base body 12 has a first circumferential end 14 and a second circumferential end 16. The clamping device 10 has a joining gap 18 between the first circumferential end 14 and the second circumferential end 16.

The first circumferential end 14 and the second circumferential end 16 each have a flat joining surface 27. The joining surfaces 27 are aligned parallel to the central axis X-X.

The first circumferential end 14 and the second circumferential end 16 each have a through-hole 26 that is aligned perpendicular to the central axis X-X. The through-holes 26 are arranged within and perpendicular to the joining surface 27.

In the fastened state, the through-holes 26 have a common fastening axis S-S. In FIG. 1, the fastening axis S-S is shown in the through-hole 26 at the first circumferential end 14.

The second circumferential end 16 has a spacer 28 that protrudes from the second circumferential end 16 towards the joining gap 18. The spacer 28 is arranged radially outside the through-bores 26 when viewed from the central axis X-X.

The clamping device 10 is preferably an injection-molded component made of a plastic material. Thus, this can be manufactured quickly and inexpensively. Furthermore, plastic has good resiliency, which allows for simple fastening of the clamping device 10 to the bicycle handlebar 50 and the component 40 to the clamping device 10.

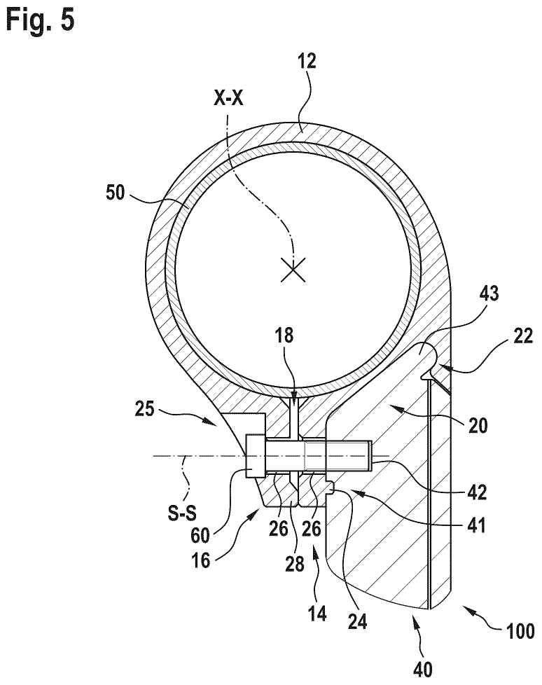

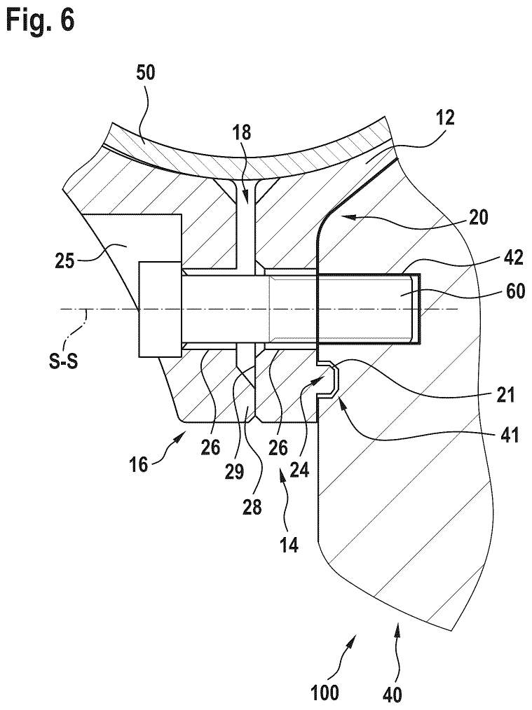

The first circumferential end 14 has an outwardly directed locking area 20. The locking area 20 is configured to form a detachable snap connection with the component 40. For this purpose, the locking area 20 has an undercut 22 and two cuboid protrusions 24, which can form the snap connection on the component 40 with a corresponding indentation 41 (shown in FIGS. 5 and 6) and lug 43 (shown in FIG. 5). The lug on the component 40 can engage with the undercut 22. By subsequently rotating the component 40, the protrusions 24 can snap into the indentations 41 of the component 40, thereby fastening the component to the clamping device.

In the locking area 20, a guide bar 23 is arranged next to the undercut 22 on both sides, such that the undercut 22 is centrally located between the guide bars 23. The guide bar 23 extends along an orthogonal plane to the central axis X-X. Thus, the guide bar 23 forms a guide and a stop for the component 40.

FIG. 2 shows a detailed view of the locking area 20.

The locking area 20 has a flat stop surface 29, which is arranged parallel to the joining surface 27. The through-hole 26 extends from and is arranged perpendicular to the stop surface 29 to the joining surface 27.

At a radial end of the locking area 20, the two cuboid protrusions 24 are arranged on the stop surface 29. The protrusions 24 have a chamfer 21, which facilitates the formation and detachment of a snap connection with the component 40. A screw 60 may be used to fix the component 40 to the stop surface 29 and to the protrusions 24.

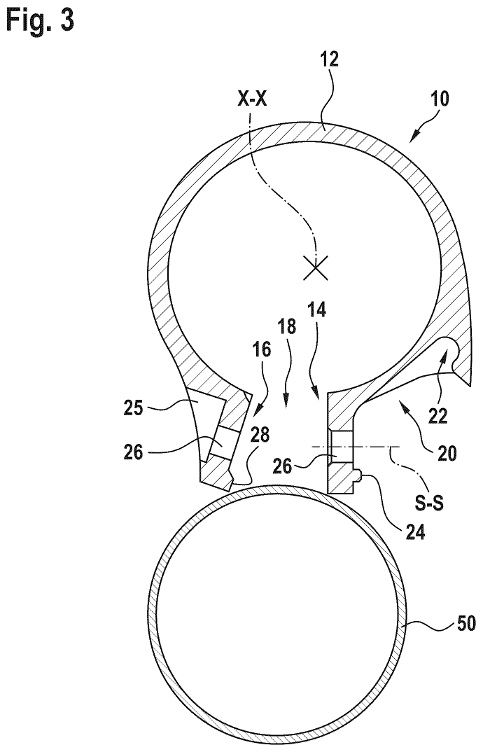

FIG. 3 shows a sectional view of the clamping device 10 and the bicycle handlebar 50. The clamping device 10 is not yet attached to the bicycle handlebar 50. The bicycle handlebar 50 has a circular cross-section.

To attach the clamping device 10 to the bicycle handlebar 50, the first circumferential end 14 and the second circumferential end 16 are bent apart such that the joining gap 18 increases. The base body 12 has such resilience that the first circumferential end 14 and the second circumferential end 16 can be bent apart so far that the joining gap 18 is wider than the diameter of the bicycle handlebar 50 without the base body 12 deforming plastically.

The second circumferential end 16 has a recess 25 on a side opposite the joining gap 18, which is configured to receive a screw head of the screw 60. The recess 25 is configured such that the screw head can rest flush against it.

FIG. 3 shows a basic state of the clamping device 10, in which the joining gap 18 is not bent open or closed by any external forces.

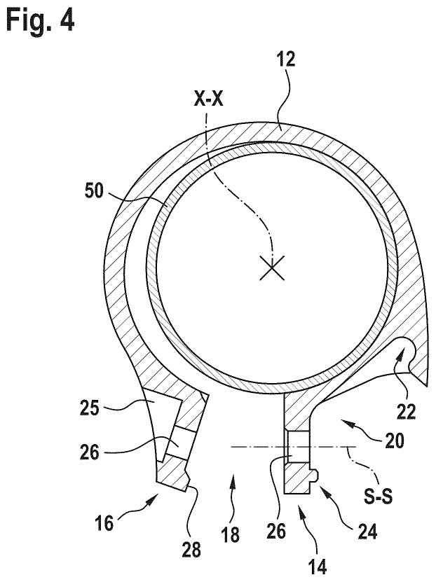

In FIG. 4, the clamping device 10 can be seen after being attached in the bicycle handlebar 50. In doing so, the clamping device 10 has returned to its basic state.

In the attached basic state, there is a clearance mount between the base body 12 and the bicycle handle 50, such that the clamping device 10 is freely movable along the bicycle handlebar 50.

The locking area 20 is geodetically arranged below the central axis X-X of the clamping device 10.

FIG. 5 shows the clamping assembly 100 consisting of screw 60, component 40 and clamping device 10. The clamping assembly 100 is fixed to the bicycle handlebar 50 with the aid of the screw 60.

For example, the component 40 is shown as a bicycle light, but may also be, for example, a bicycle computer, a bell, an additional sensor or an input unit.

The component 40 forms a detachable snap connection with the locking area 20. The lug 43 of the component 40 thereby engages in the undercut 22 of the clamping device 10. Furthermore, the protrusion 24 of the clamping device 10 engages in the associated indentation 41 of the component 40.

The component 40 is fixed to the clamping device 10 with the aid of the screw 60. The screw extends through the through-holes 26 in the first circumferential end 14 and the second circumferential end 16 and engages in an associated threaded hole 42 in the component 40. The threaded hole 42 is arranged coaxially to the through-holes 26. The screw head abuts the recess 25 of the second circumferential end 16 such that the screw 60 contracts the second circumferential end 16 and the component 40.

The second circumferential end 16 abuts the spacer 28 against the joining surface 27 of the first circumferential end 14. There is also a narrow joining gap 18 between the joining surface 27 of the first circumferential end 14 and the joining surface 27 of the second circumferential end 16. By screwing the screw 60 further into the component 40, the joining gap 18 can be reduced, which increases the clamping force of the clamping device 10 on the bicycle handlebar 50.

FIG. 6 shows a detailed view of the clamping assembly 100 of FIG. 5 in the area of the joining surface.

It can be seen that the through-hole 26 in the first circumferential end 14 has a larger diameter than the through-hole 26 in the second circumferential end 16. Furthermore, the through-hole 26 in the first circumferential end 14 has a chamfer 21, which is adjacent the joining gap 18. The larger diameter and chamfer 21 in the first circumferential end 14 facilitate insertion of the screw 60 when the through-holes 26 in the first and second circumferential ends 14, 16 are non-coaxially aligned with each other.

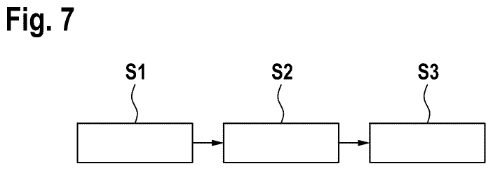

FIG. 7 shows a flow chart of a method for fastening the component 40 to the bicycle handlebar 50.

In a first step S1, the clamping device 10 is attached to the bicycle handlebar 50. To this end, the clamping device 10 is preferably bent open to such an extent that the joining gap 18 is wider than the diameter of the bicycle handlebar 50. After the clamping device 10 has been attached to the bicycle handlebar, it preferably bends back to the base state.

In a second step S2, the component 40 is fastened to the clamping device 10 by way of a detachable snap connection.

Alternatively, the component 40 may also be fastened to the clamping device 10 before the clamping device 10 is fastened to the bicycle handlebar 50.

Finally, in a third step S3, the clamping device 10 is fixed to the bicycle handlebar 50 and at the same time the component 40 is fixed to the clamping device 10 with precisely one screw 60. Thus, with the aid of the clamping device 10, the component 40 can be fixed to the bicycle handlebar 50 in a few steps.

What is claimed is:

1. A clamping device for fastening a component to a bicycle handlebar, comprising:
an open annular base body bent about a central axis and having a first circumferential end and a second circumferential end;
a locking area configured to form a detachable connection with the component; and
wherein the base body is configured to enclose the bicycle handlebar,
wherein, in the assembled state, a joining gap is defined between the first circumferential end and the second circumferential end,
wherein the locking area is arranged at the first circumferential end,
wherein the first circumferential end and the second circumferential end are configured to be connected by at least one fastening element along a fastening axis in order to fix the clamping device to the bicycle handlebar, and
wherein the locking area is configured to fix the component in addition to the detachable connection by way of the at least one fastening element.

2. The clamping device according to claim 11, wherein the locking area has an undercut and a protrusion which are configured to form the detachable snap connection with the component.

3. The clamping device according to claim 2, wherein:
the protrusion from the base body is arranged radially outside the fastening axis at the first circumferential end, and
the undercut is arranged between the central axis and the fastening axis.

4. The clamping device according to claim 1, wherein the first circumferential end and the second circumferential end have through-holes which are configured to receive the at least one fastening element.

5. The clamping device according to claim 1, wherein the first circumferential end and/or the second circumferential end have a spacer arranged radially outside the fastening axis from the base body and protruding into the joining gap.

6. The clamping device according to claim 1, further comprising a guide bar arranged adjacent the undercut and forming a lateral stop in the direction along the central axis.

7. The clamping device according to claim 1, wherein the clamping device is formed so as to be one piece.

8. A clamping assembly, comprising:
a fastening element;
a component; and
a clamping device according to claim 1, wherein the clamping device is configured to fix the component to a bicycle handlebar by way of the fastening element.

9. The clamping assembly according to claim 8, wherein the clamping assembly is configured to geodetically fix the component below the bicycle handlebar.

10. A method of fastening a component to a bicycle handlebar, comprising:
attaching a clamping device according to claim 1 to the bicycle handlebar;
fastening the component to the clamping device; and
fixing the clamping device to the bicycle handlebar and the component to the clamping device with a fastening element.

11. The clamping device according to claim 1, wherein the detachable connection is a detachable snap connection.

12. The clamping device according to claim 1, wherein the at least one fastening element includes precisely one screw.

13. The clamping assembly according to claim 8, wherein the fastening element includes precisely one screw.

14. The method of claim 10, wherein the fastening clement includes precisely one screw.
